(19) United States
(12) Patent Application Publication
(10) Pub. No.: US 2003/0052288 A1
(43) Pub. Date: Mar. 20, 2003

(54) Method and apparatus for measuring fill level in bottles

(75) Inventor: Fred L. Calhoun, Rolling Hills, CA (US)

Correspondence Address: Irving Keschner, Suite 1150, 21515 Hawthorne Boulevard, Torrance, CA, 90503, US

(73) Assignee: Industrial Dynamics Company, Ltd.

(21) Appl. No.: 09/957,438

(22) Filed: Sep. 19, 2001

(51) Int. Cl. G01N 15/06

(52) U.S. Cl. 250/577

(57) ABSTRACT

Method and apparatus for measuring the liquid fill level in bottles while the bottles are still within the turret section of the filler system. A source of focused light, such as that generated by a laser, is directed onto a series of targets positioned on the turret behind the bottles. The beam is directed back through the bottle neck and detected by a remote camera. The detected image varies depending upon whether the bottle was underfi

### BACKGROUND OF THE INVENTION

1. Field of the Invention

The present invention provides method and apparatus for measuring the fill level in containers, such as transparent bottles and jars, while the bottles are still within the filler turret section of the filler apparatus.

2. Description of the Prior Art

Systems for measuring the fill level in bottles have been commercially available for many years. In most modern beverage fillers, the bottles from the infeed starwheel are placed on a bottom stirrup in the filler rotary turret. Each of the stirrups are movable in the vertical direction and are lifted by a mechanism, such as a cam, so that the top of each bottle is engaged into a filling cup. This cup seals the internal volume of the bottle from normal atmospheric conditions. A vacuum is usually applied to each bottle and the filler then allows the beverage to flow into the bottle. By first applying the vacuum, the bottles may be filled faster and minimizes foaming in carbonated beverages. The bottles are filled with liquid and then are lowered by cam down to the same bottom position as they were in the infeed starwheel. As the stirrup is lowered by the cam to the proper position, the bottles are handed off to transition starwheel where they are fed into a bottle capper. Prior to capping, carbonated beverages are usually jetted with some form of liquid or gas that makes them foam-over, allowing the foam to displace any air in the volume between the liquid level and the top of the bottle.

U.S. Pat. No. 3,133,638 issued to the inventor of the instant application, discloses an inspection apparatus which utilizes two vertically aligned photocells which monitor the light provided through an inspection zone from a source of light. A third photocell provides an indication when the bottle enters the inspection zone. The light from the source passes through the neck area of the bottle and the light diffusing characteristics of the liquid determines where the diffused light is focused on an image plane by a lens. The lens, in turn, focuses the light on either one of two positions at the image plane on either or both, of the vertically aligned photocells depending upon the fill level in the bottle.

Although the measuring apparatus disclosed in the '638 patent provides excellent results, the inspection is initiated after the bottles have been capped in a previous operation. Inspecting fill levels after capping and providing the support mechanism for doing so adds to the cost and complexity of the inspection system.

What is therefore desired is to provide a liquid fill level measuring system wherein the inspection is completed while the bottles are still within the rotary turret section of the filler system.

### SUMMARY OF THE PRESENT INVENTION

The present invention provides method and apparatus for measuring the liquid fill level in bottles while the bottles are still within the turret section of the filler system. Measuring the bottles for fill level while they are in the filler turret enables the exact valve number that fills each bottle to be known without complex memory systems tracking the bottle downstream of the filler station to the reject station. As stated hereinabove, in the carbonated beverage industry, the bottles are usually “foamed over” before the capper station to purge any oxygen in the headspace above the liquid to prevent oxidation of their content which can change the true fill point in the bottles. The present invention avoids inaccurate measurements downstream of the capper station by measuring the fill level prior to capping. Further, the newer beverage filler systems have electronic controlled valves that are adjusted, or tuned, to provide the desired bottle fill level. In accordance with the teaching of the present invention, the exact liquid level, as measured by the system optics, is used as a signal for the electronics that control the filler valves enabling the operator to set the desired fill level in the bottles and detect faulty or malfunctioning valves at the early stages of the filling process, thus reducing the number of improperly filled bottles that must be discarded and, in turn, reducing process costs.

### DESCRIPTION OF THE DRAWING

For a better understanding of the present invention as well as other objects and further features thereof, reference is made to the following description which is to be read in conjunction with the accompanying drawing therein:

FIG. 1 is a schematic of a fill level apparatus modified in accordance with the teachings of the present invention;

FIG. 2 is a schematic top view of the optical system of the present invention;

FIG. 3 illustrates in more detail how the bottle fill level is detected, the output on a computer monitor being superimposed thereon; and

FIG. 4 illustrates the illumination return beam path.

### DESCRIPTION OF THE INVENTION

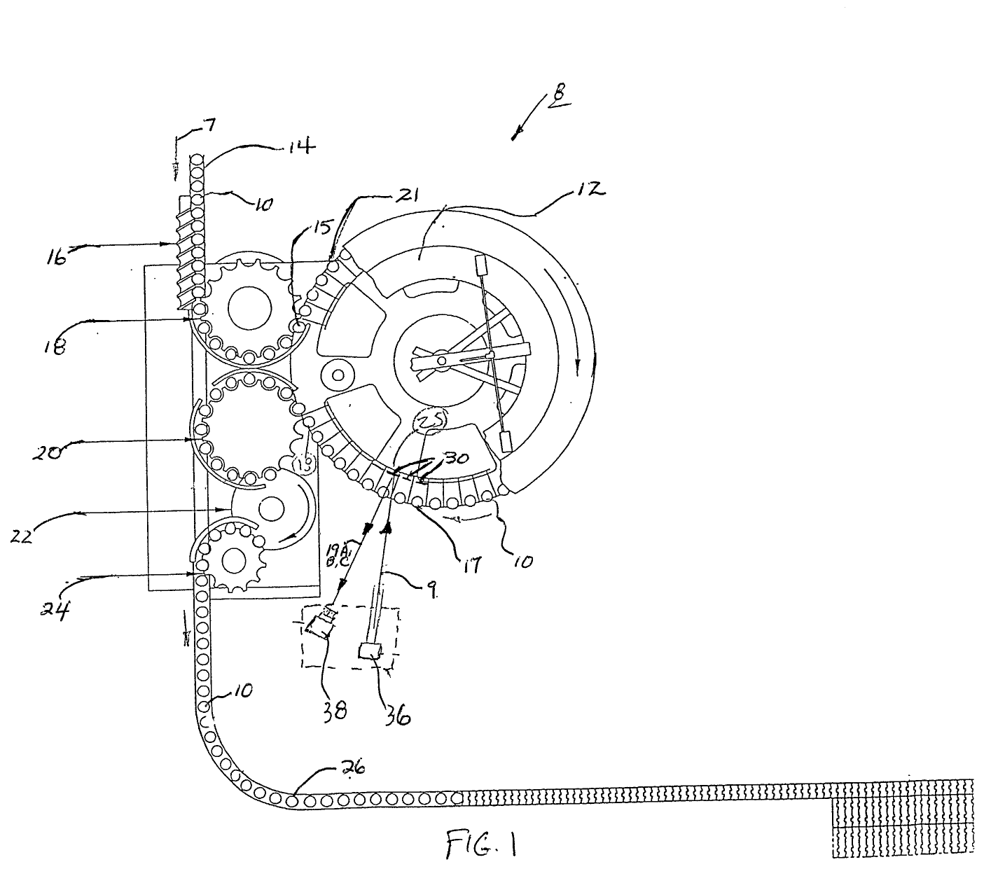

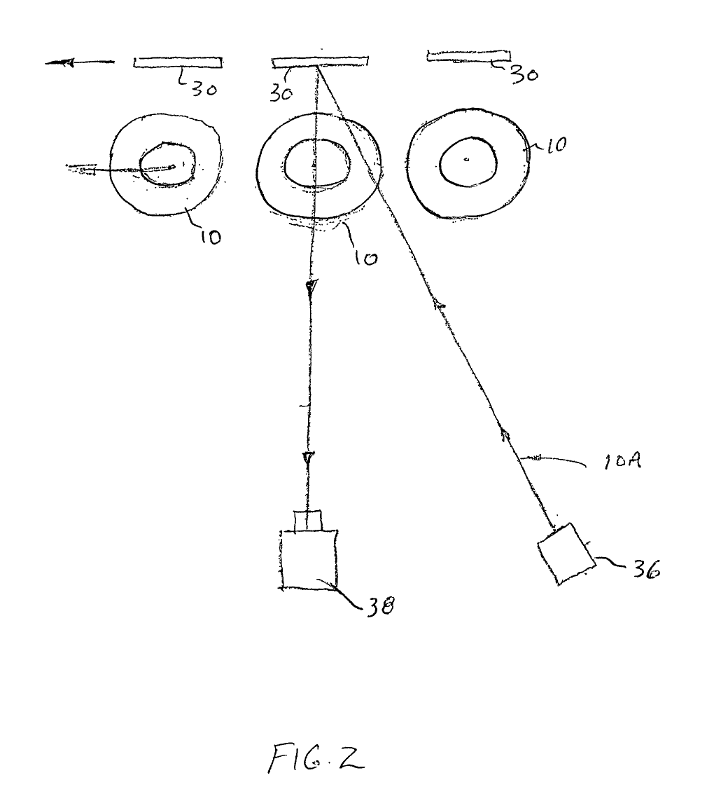

Referring now to FIG. 1, a top view of a conventional beverage filler system 8 used to fill and measure, or inspect, cola, beer and water bottles is illustrated. The bottles 10 are fed into the rotating filler turret 12 by means of a chain type conveyor 14 moving in the direction of arrow 7. A timing screw 16 spaces the bottles 10 into the infeed starwheel 18 which then places the bottles 10 into the rotating filler turret 12. As the bottles 10 travel around the turret 12, they are filled with the beverage and then placed into the transition starwheel 20 which hands them off to capper 22. Bottles 10 are fed from capper 22 into the outfeed starwheel 24 which deposits them on the outfeed conveyor 26. The bottles are precisely indexed from the infeed starwheel 18 through the filler turret 12, transition starwheel 20, capper 22 and into the outfeed starwheel 24. Precise indexing is required since the filler system 8 operates at a high rate of speed ( up to 1200 bottles per minute) and any deviation in bottle placement can cause damage to the bottles and/or filling equipment. The bottles 10 from infeed starwheel 18 are placed on a bottom stirrup in filler turret 12 at position 15. Each of the stirrups are movable in the vertical direction and are lifted by a mechanism, such as a cam, so that the top of each bottle 10 is engaged into a filling cup at position 21. The cup seals the internal volume of the bottle from normal atmospheric conditions. A vacuum is applied to each bottle 10 and the filler enables the fluid beverage to flow into the bottle (the vacuum allows the bottles to be filled rapidly and minimizes foaming in the carbonated beverages). The bottles are filled with liquid by the time the bottles reach position 17 and are then lowered by a cam to the same level they were in infeed starwheel 18. As the stirrup is lowered to the proper position, bottles 10 are handed off to transistion starwheeel 20 and then fed to capper 22. Prior to capping, carbonated beverages are jetted with liquid or gas that makes the beverage foam, the foam displacing any air in the volume between the liquid level and the top 23 of bottle 10 (headspace).

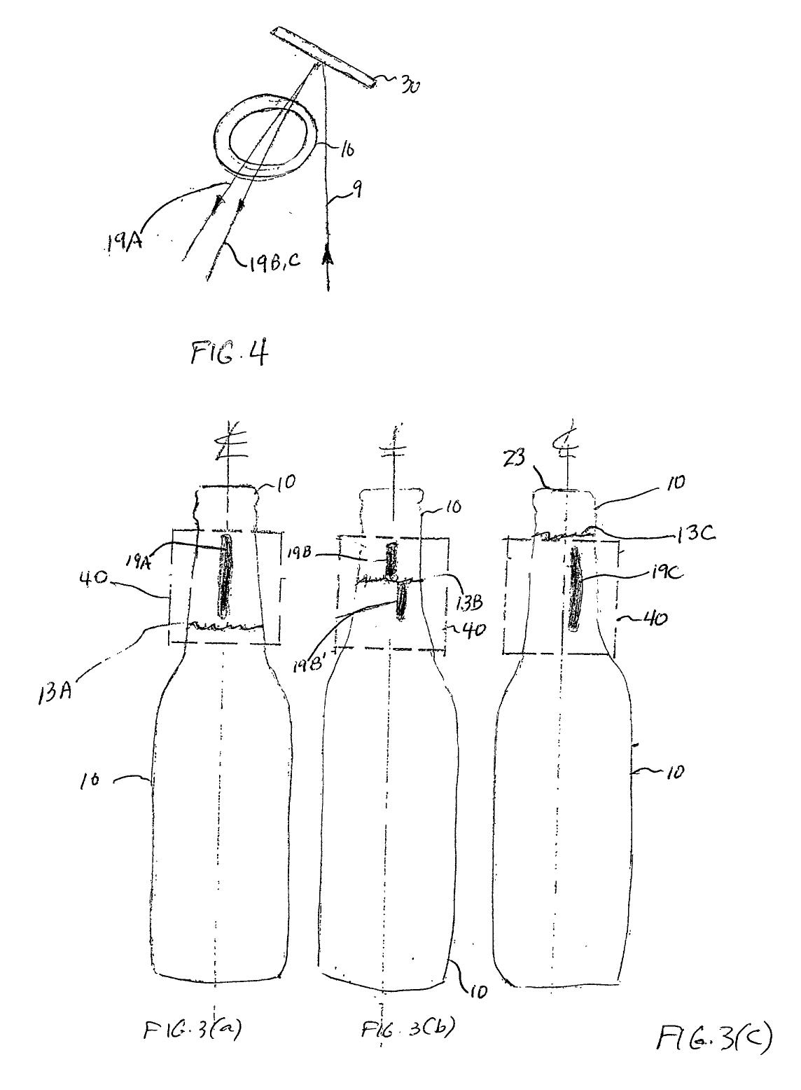

In accordance with the teachings of the present invention, the conventional method of measuring bottle fill levels downstream from the capping station is modified by measuring the fill level when the bottles are still positioned on the rotating turret 12. In particular, a plurality of targets 30, each comprised of a vertical panel preferably rectangular in shape), are mounted to backplates positioned behind each bottle turret position on filler turret 12 so it overlaps the entire range of fill level positions 13 in the vertical direction (FIGS. 3(a)-3(c)). Targets 30 comprise a material that diffuses the incident light beam 9 in such a manner that the image 19 of an illumination source 36 is formed on each target 30 as shown in FIG. 3. In this regard, conventional reflective targets will not function since “backlighting” is needed as a light source for the imaging system of the present invention. Corner-reflective tape, such as those manufactured by the 3M Company, Mineapolis, Minn., or similar material, are the preferred target material. Specifically, the characteristics of the target material are such that it must not reflect a major portion of the incident illumination; otherwise it will not function as the required secondary light source behind the bottles (paper has these characteristics also). A video camera 38 is positioned so its field of view 40 is placed over the fill level range of the bottles 10 being filled. The image of the light source on the target 30 is viewed by the camera 38 as it looks through the neck of each bottle 10 as they are moved pass camera 38 by the turret 12.

The light source image 19, as viewed by camera 38, appears in different formats depending upon the fill level 13a, 13b and 13c in each bottle 10. FIGS. 3(a)-3(c) illustrate these images assuming that no image distortion takes place as the light from the bright image on the targets 30 travel through the bottle neck back to the camera 38. As the bottles 10 pass in front of line of sight between each target 30 and camera 38, the image 19 of the bottle 10 will sweep across the camera field of view 40. Since the bottle 10 is cylindrical in shape, the portion containing the liquid acts as a lens and offsets the target image from the bottle centerline 27 based on the liquid level as shown in FIGS. 3 (a)-3(b), and 3(c) for an underfilled (image 19A), properly filled (image 19B) and an overfilled bottle (image 19C), respectively. FIG. 4 is a simplified top view illustrating the return beam path when no liquid is present (19A) and when liquid is present (19B and 19C). The lens action of the liquid in the bottle neck can be clearly seen in FIG. 4 as the beams incident on the liquid are refracted toward the denser medium.

An intense source of light which can provide a sharply focused beam 9 is preferred since much of the illumination is lost on the type of target that must be used to form the back lighted source for inspection. A laser whose spectral output can be sensed by video camera 38 is the preferred source of illumination. For optimum inspection purposes, the light source 36 is activated at all times since the images of the bottle necks rapidly sweep across the camera field of view 40. This requirement essentially precludes the use of strobe light sources; other filament sources are not typically bright enough and have limited life.

The camera field of view 40 may be calibrated so the received image gives the exact fill level in each bottle. The information from this image, after calibration, can be used for graduated fill level measurements and for controlling the filler valves.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. Apparatus for measuring the level of liquid in a container having a centerline wherein the liquid has the property of diffusing an illumination beam passing through the liquid comprising:
a source for generating an illumination beam, said beam being directed to a target behind said container and then through the liquid in said container;
means disposed relative to the container for receiving the illumination beam passing through said container in the form of an image; and
means operatively coupled to said receiving means for providing an indication of the liquid level in said container.

2. The apparatus of claim 1 wherein said target is positioned on a rotating member.

3. The apparatus of claim 1 where said source of illumination comprises a laser.

4. The apparatus of claim 1 wherein the liquid fill level is based on the offset of said image from said container centerline.

5. A method for measuring the level of liquid in a container having a centerline comprising the steps of:
generating an illumination beam;
directing said illumination beam to a target positioned behind said container;
directing the illumination beam reflected from said target through the liquid in said container;
receiving the illumination beam passing through said container in the form of an image; and
providing an indication of the liquid level in said container based on the received illumination.

6. The method of claim 5 wherein said illumination beam is generating by a laser.

7. The method of claim 5 wherein the liquid level is based on the offset of said image from said container centerline.
